(19) United States
(12) Patent Application Publication
(10) Pub. No.: US 2009/0159724 A1
(43) Pub. Date: Jun. 25, 2009

(54) TURBINE VALVE

(76) Inventor: Mark S. Kacik, Strongsville, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/962,410

(22) Filed: Dec. 21, 2007

(51) Int. Cl. B05B 3/04; B05B 1/08; B05B 1/18

(52) U.S. Cl. 239/383; 251/59

(57) ABSTRACT

A fluid spray apparatus, such as a multi-function showerhead, produces a pulsating spray pattern by rotation of a turbine in a chamber under the force of the fluid flowing through the fluid spray apparatus. A portion of the fluid flowing through the fluid spray apparatus is used to create a fluidic bearing so that the turbine does not contact a wall of the chamber during normal operation of the fluid spray apparatus.

### FIELD

The invention relates generally to a fluid spray apparatus and, more particularly, to a fluid spray apparatus capable of producing a pulsating discharge pattern using a fluidic bearing.

### BACKGROUND

Certain conventional multi-function showerheads represent an exemplary fluid spray apparatus that is capable of producing a pulsating spray pattern. By way of example, U.S. Pat. No. 5,201,468 assigned to the Kohler Co. of Kohler, Wis., the entire disclosure of which is hereby incorporated by reference, discloses that in many spray apparatus, a turbine valve rotates in a chamber under the force of the water flowing through the spray apparatus. As the turbine valve rotates, a plate on the turbine valve alternately opens and closes different outlets from the chamber. This action produces a pulsating water flow through the outlets. The water forces the turbine valve against the surface of the chamber producing friction which impedes the rotation of the turbine valve. Under low flow rates, this friction often is sufficient to inhibit rotation of the turbine valve and thereby eliminate the pulsating action.

The '468 patent describes various prior techniques for reducing the friction between the turbine valve and the wall of its chamber. In one technique, the wall has raised pads at the location of the outlet openings so that the turbine rides against the smaller surface of these pads, thereby reducing the frictional force to which the turbine valve is subjected. Additional structure in the form of ribs extending between the pads guides the plate of the turbine valve from one raised pad to the next.

As a purported improvement over these prior techniques, the '468 patent discloses a preferred embodiment of a fluid spray apparatus in which, among other things, one of the fluid passages includes a circular chamber in which a forced vortex is created by fluid flow through the passage. One group of outlets extends through and is spaced circumferentially around a wall of the chamber. A turbine is disposed within the chamber for rotational movement in response to the forced vortex. The turbine has a base plate that serves as a valve to alternately open and close openings to the group of outlets as the turbine moves within the chamber. This action produces a pulsating fluid flow from those outlets. The surfaces of the chamber wall and the turbine base plate that come into contact with each other are textured to reduce friction therebetween. As such both surfaces have fine peaks and the components touch at the peaks thereby reducing the surface area of the contact.

The technique disclosed in the '468 patent involves the turbine base plate contacting surfaces of the chamber wall during operation of the fluid spray apparatus. Accordingly, friction still arises from the contact between the turbine and the chamber wall, which impedes the rotation of the turbine and contributes to increased wear between the contacting components. Consequently, there is a need in the art for a fluid spray apparatus that is capable of producing a pulsating spray pattern by rotation of a turbine in a chamber under the force of the water flowing through the spray apparatus, wherein the turbine does not contact a wall of the chamber during normal operation.

### SUMMARY

In view of the above, it is an exemplary aspect to provide a fluid spray apparatus for producing a pulsating spray pattern by rotation of a turbine in a chamber under the force of the fluid (e.g., water) flowing through the fluid spray apparatus, wherein the fluid flowing through the fluid spray apparatus is used to create a fluidic bearing so that the turbine does not contact a wall of the chamber during normal operation.

Numerous other advantages and features will become readily apparent from the following detailed description of exemplary embodiments, from the claims and from the accompanying drawings.

### BRIEF DESCRIPTION OF THE DRAWINGS

The above aspects and additional aspects, features and advantages will become readily apparent by describing in detail exemplary embodiments thereof with reference to the attached drawings, wherein like reference numerals denote like elements, and:

FIGS. 1A-1D show a partial head portion of a multi-function showerhead, according to an exemplary embodiment. FIG. 1A is a top plan view of the partial head portion. FIG. 1B is a cross-sectional view of the partial head portion of FIG. 1A, along line A-A. FIG. 1C is a cross-sectional view of the partial head portion of FIG. 1B, along line B-B. FIG. 1D is a cross-sectional view of the partial head portion of FIG. 1B (similar to that shown in FIG. 1C), with a turbine valve and a rubber pad that defines the nozzle dimensions removed.

FIGS. 2A-2J show a turbine valve, according to an exemplary embodiment, for use in the partial head portion of FIGS. 1A-1C. FIG. 2A is a top perspective view of the turbine valve. FIG. 2B is a bottom perspective view of the turbine valve. FIG. 2C is a top plan view of the turbine valve. FIG. 2D is a bottom plan view of the turbine valve. FIG. 2E is a cross-sectional view of the turbine valve shown in FIG. 2C, along line A-A. FIG. 2F is a detailed view of portion A of the turbine valve shown in FIG. 2E. FIG. 2G is a cross-sectional view of the turbine valve shown in FIG. 2E, along line B-B. FIG. 2H is a detailed view of portion B of the turbine valve shown in FIG. 2G. FIG. 2I is a detailed view of portion C of the turbine valve shown in FIG. 2H. FIG. 2J is a side elevational view of the turbine valve.

### DETAILED DESCRIPTION

While the general inventive concept is susceptible of embodiment in many different forms, there are shown in the drawings and will be described herein in detail specific embodiments thereof with the understanding that the present disclosure is to be considered as an exemplification of the principles of the general inventive concept. Accordingly, the general inventive concept is not intended to be limited to the specific embodiments illustrated herein.

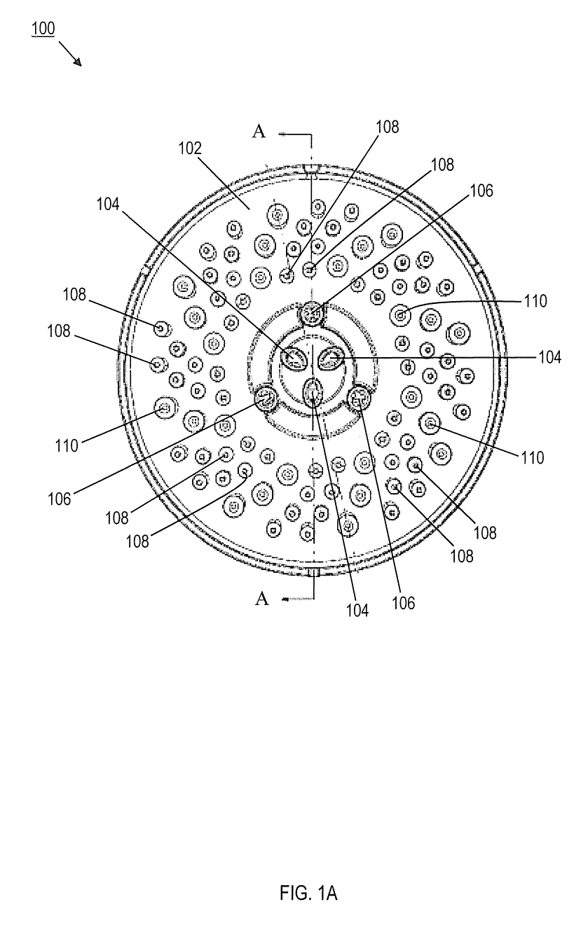

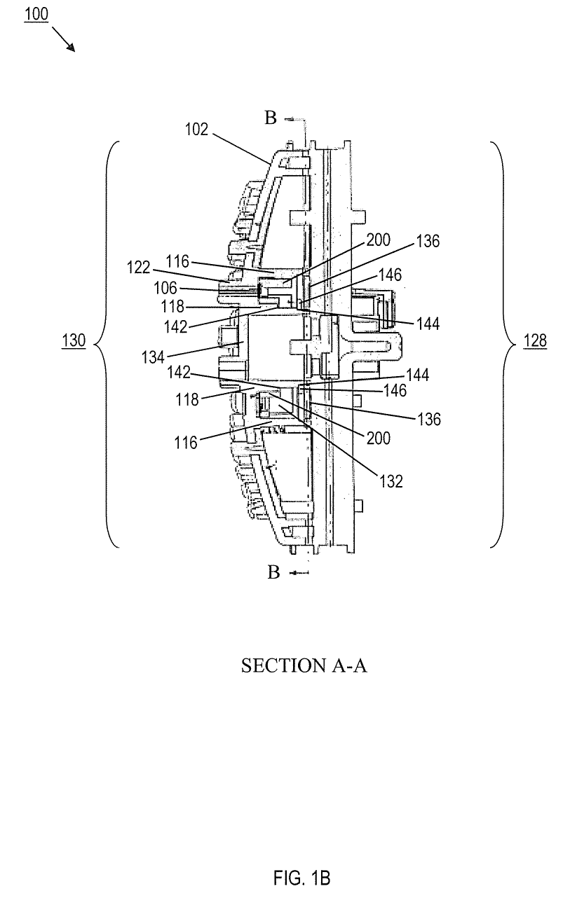

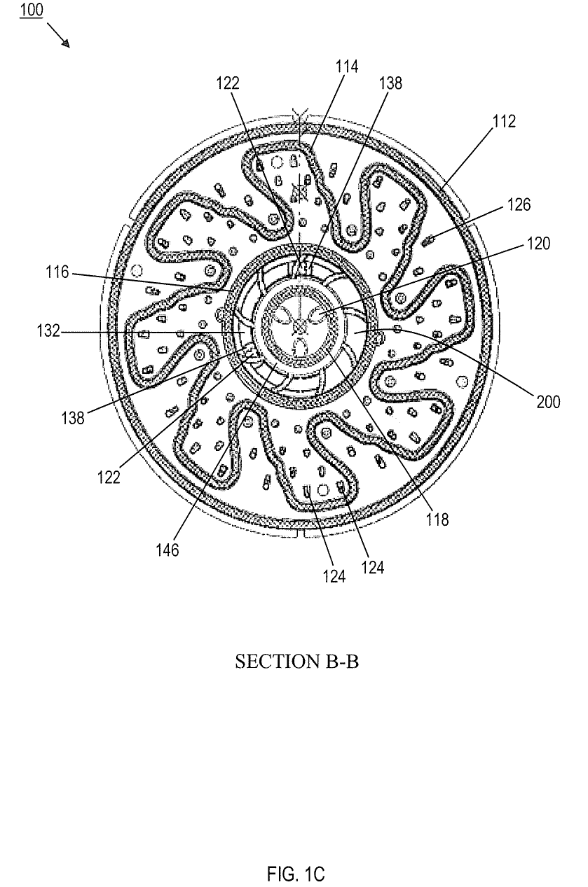

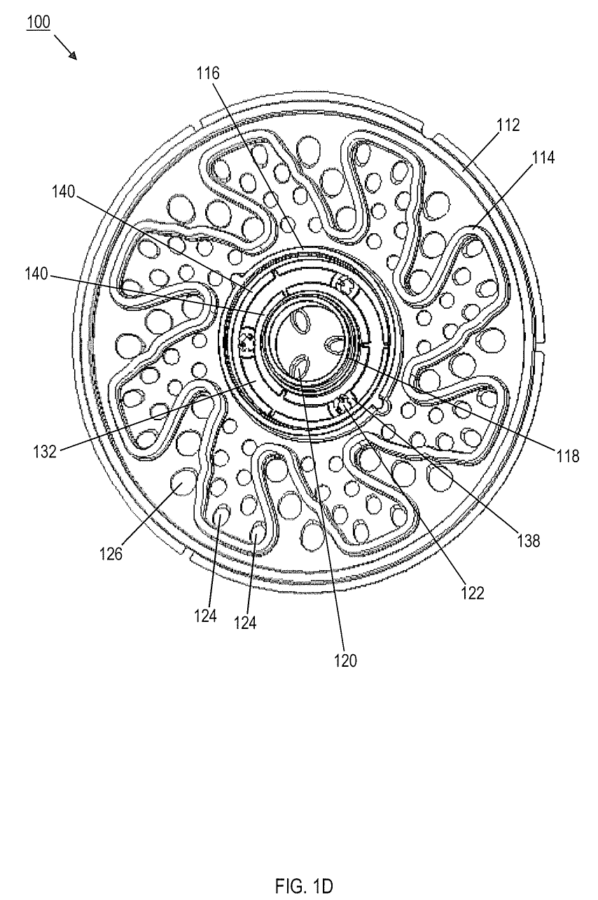

With reference to FIGS. 1A-1C, an exemplary embodiment of the present invention is described in the context of a partial head portion 100 of a multi-function showerhead capable of producing a pulsating spray pattern.

A face 102 of the partial head portion 100 of the multi-function showerhead includes a plurality of different nozzle openings 104, 106, 108 and 110 (see FIG. 1A). A size, shape and/or arrangement of the various nozzle openings 104, 106, 108 and 110 can contribute to different water delivery functions (e.g., spray, mist) of the multi-function showerhead. Nozzles 120, 122, 124 and 126 including the different nozzle openings 104, 106, 108 and 110, respectively, can belong to different function groups corresponding to the different water delivery functions. The nozzles 120, 122, 124 and 126 of the different function groups are separated by walls formed inside the partial head portion 100 of the multi-function showerhead, such as walls 112, 114, 116 and 118 (see FIGS. 1C and 1D). Waterways (not shown) formed in the multi-function showerhead allow water from a water supply source to be delivered to the nozzles 120, 122, 124 and 126 of the different function groups independently. The nozzles 120, 122, 124 and 126 allow the water from the water supply source passing through from an input side 128 of the partial head portion 100 to continue out an output side 130 of the partial head portion 100 through the nozzle openings 104, 106, 108 and 110 (see FIGS. 1A-1C). As in the case of the nozzle openings 104, 106, 108 and 110, a size, shape and/or arrangement of the various nozzles 120, 122, 124 and 126 can contribute to the different water delivery functions of the multi-function showerhead.

Walls 116 and 118 form an annular chamber 132 in the partial head portion 100 of the multi-function showerhead (see FIGS. 1B and 1D). In particular, wall 116 is an outer wall of the annular chamber 132 and wall 118 is an inner wall of the annular chamber 132. The outer wall 116 and the inner wall 118 are connected by a front wall 134 closer to the output side 130 of the partial head portion 100 and a rear wall 136 closer to the input side 128 of the partial head portion 100. The nozzles 122 extend through and are spaced circumferentially around the front wall 134 of the annular chamber 132. In one exemplary embodiment, the nozzles 122 are evenly spaced around the circumference of the front wall 134, i.e., with a center of each nozzle 122 being 120 degrees from a center of each adjacent nozzle 122 in the case of three nozzles 122.

The front wall 134 has raised pads 138 at the opening of each of the nozzles 122 formed in the front wall 134. Additionally, ribs 140 extend between the raised pads 138. The raised pads 138 and the ribs 140 reduce a contact area between a turbine valve 200 (described below) and the front wall 134, thereby reducing the friction between the turbine valve 200 and the front wall 134 as the turbine valve 200 transitions from an idle (i.e., non-rotational) state to an operational (i.e., fully rotating) state. FIG. 1C illustrates the partial head portion 100 with the turbine valve 200 disposed therein, while FIG. 1D illustrates the partial head portion 100 without the turbine valve 200.

The inner wall 118 has a first portion closer to the output side 130 of the partial head portion 100, a second portion closer to the input side 128 of the partial head portion 100 and a third portion between the first portion and the second portion. A radial thickness of the first portion of the inner wall 118 is greater than a radial thickness of the third portion of the inner wall 118. A radial thickness of the third portion of the inner wall 118 is greater than a radial thickness of the second portion of the inner wall 118. Accordingly, a first ledge 142 is formed between the first and third portions of the inner wall 118, and a second ledge 144 is formed between the second and third portions of the inner wall 118 (see FIG. 1B). The first ledge 142 and the second ledge 144 are formed on an exterior surface of the inner wall 118, i.e., the surface closest to the outer wall 116.

A user can select one of the water delivery functions of the multi-function showerhead by using a selector (not shown) such as a switch or a dial disposed on the multi-function showerhead. At least one of the water delivery functions of the multi-function showerhead produces a pulsating spray pattern. In one exemplary embodiment, the three nozzles 122 (and corresponding nozzle openings 106) are used to produce the pulsating spray pattern.

In the pulsating spray pattern, at least one of the nozzles 122 is covered and at least one of the nozzles 122 is uncovered in an alternating fashion. In one exemplary embodiment, when one of the nozzles 122 is covered, the remaining two nozzles 122 are uncovered. By rapidly changing the one nozzle 122 that is covered and, thus, the two nozzles 122 that are uncovered, the multi-function showerhead is capable of producing a pulsating spray pattern.

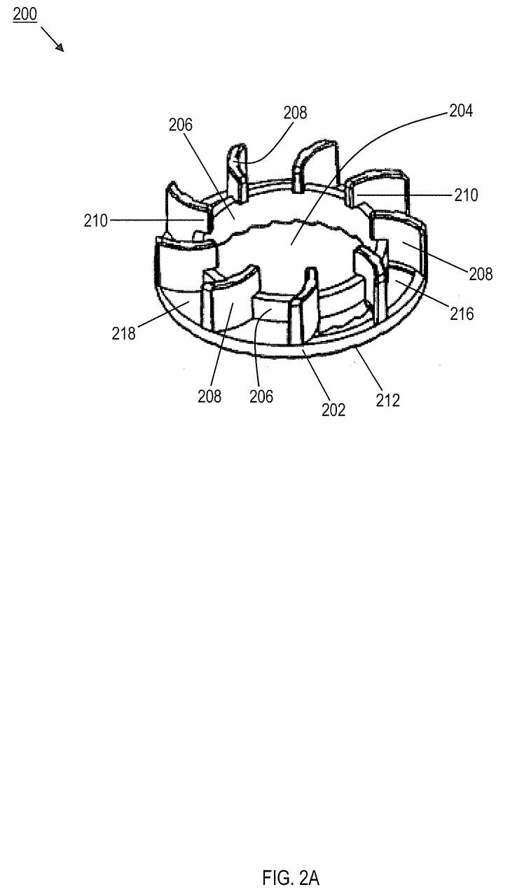

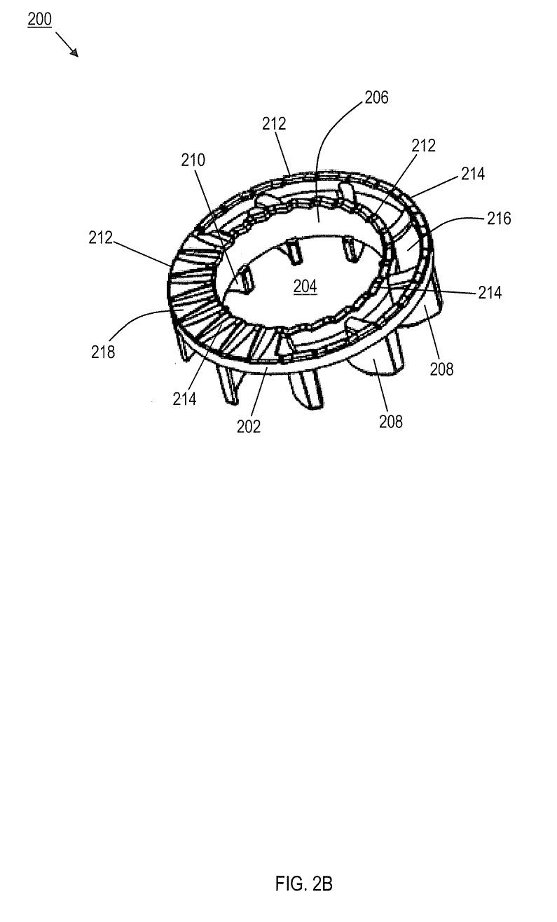

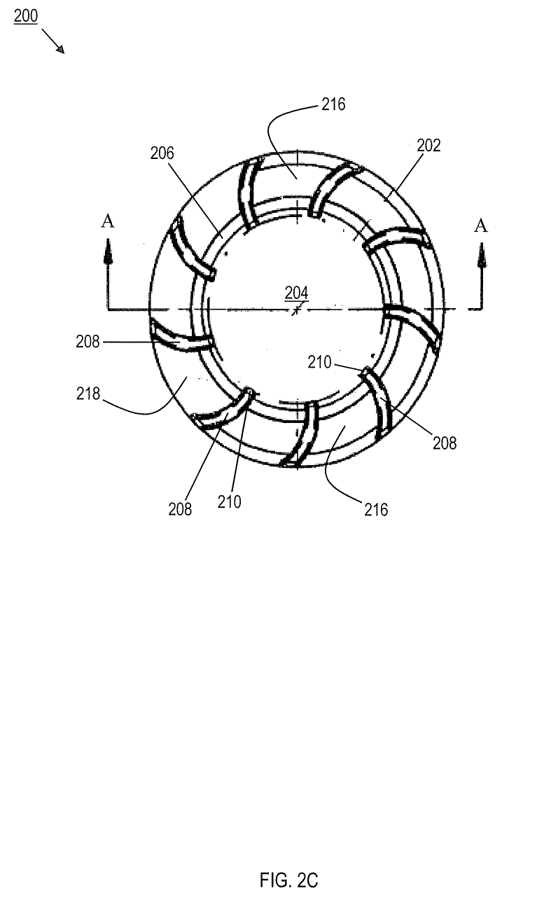

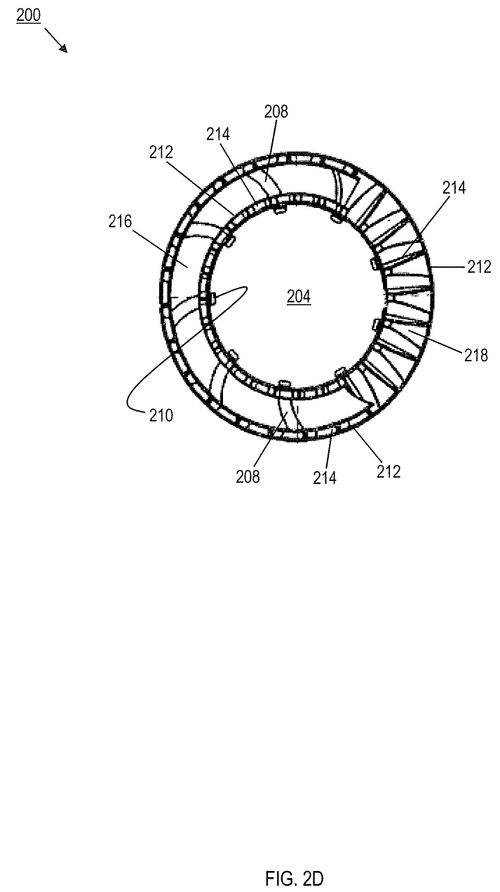

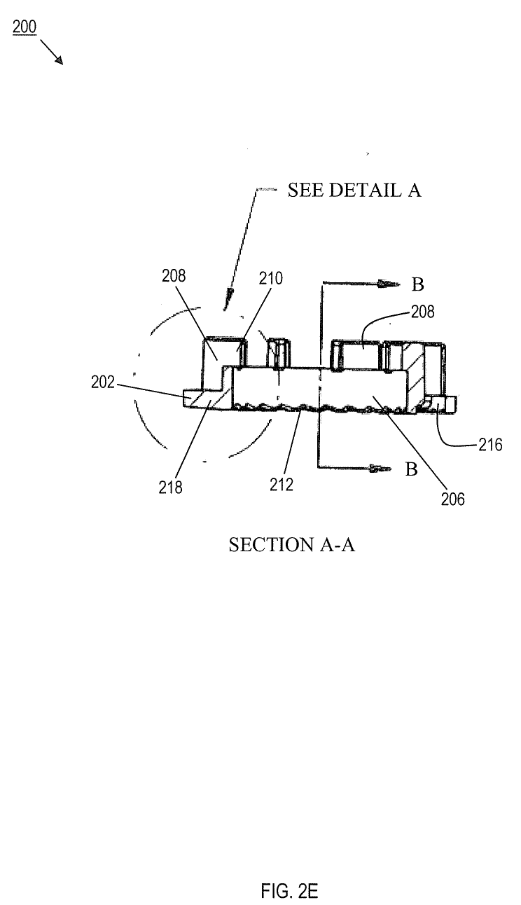

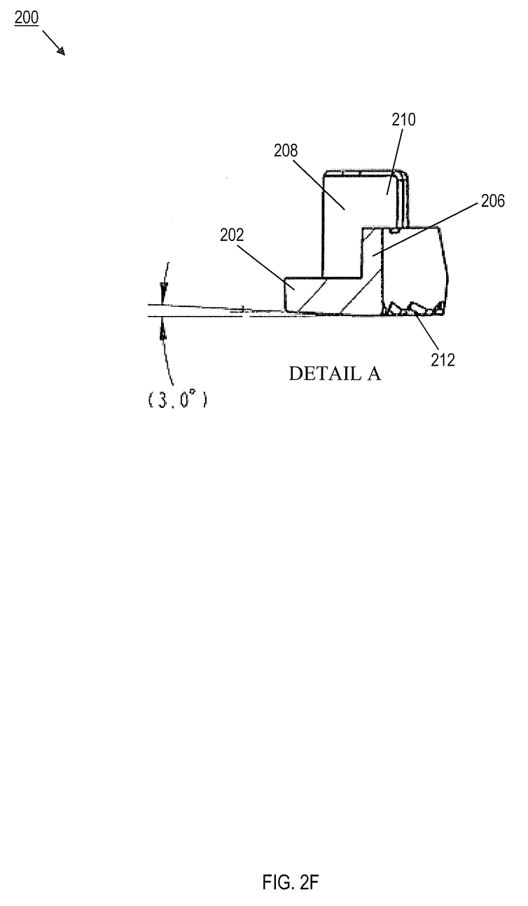

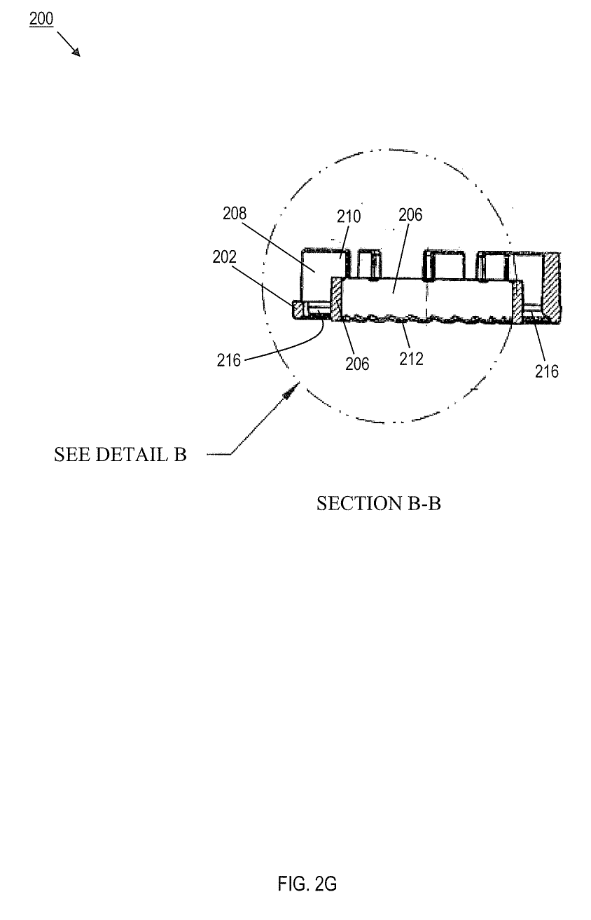

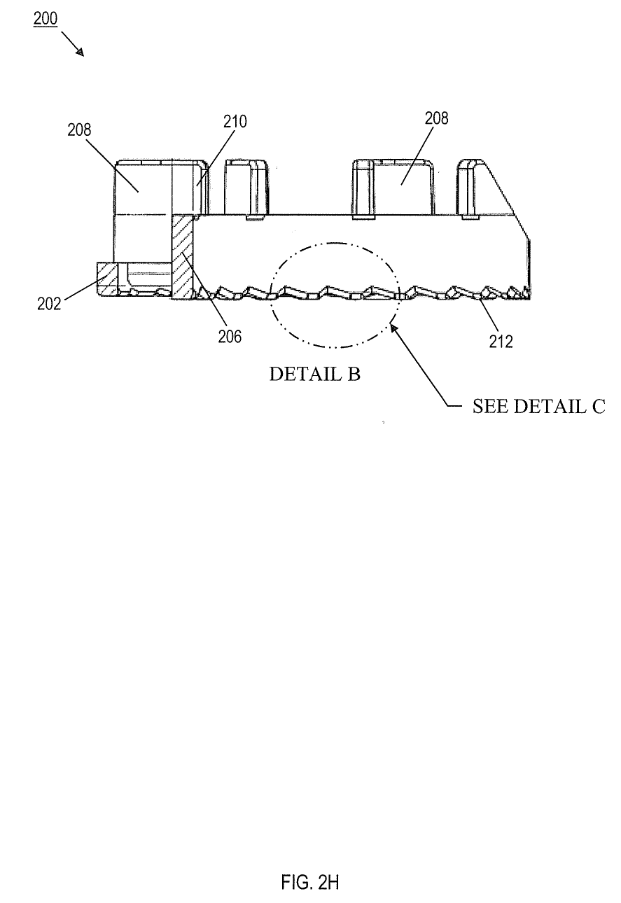

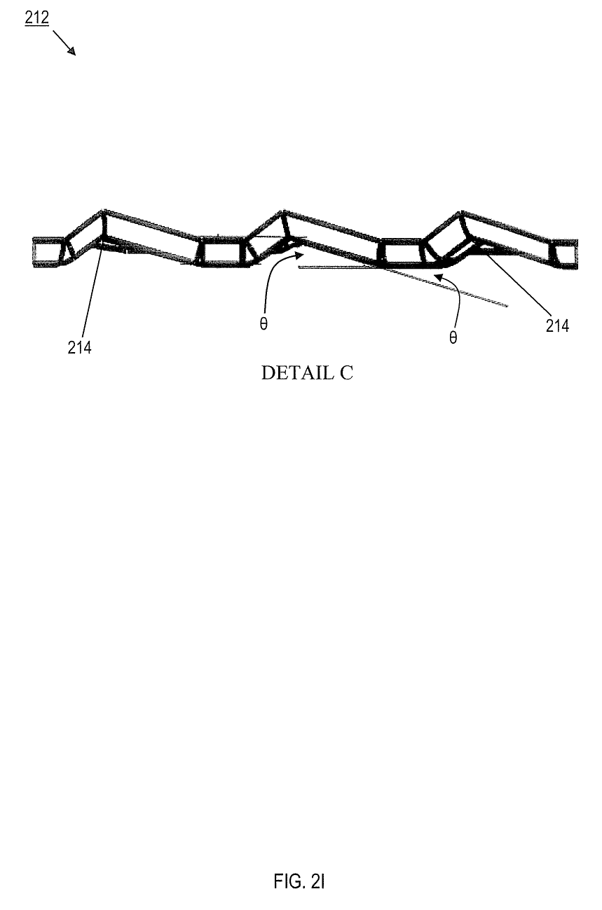

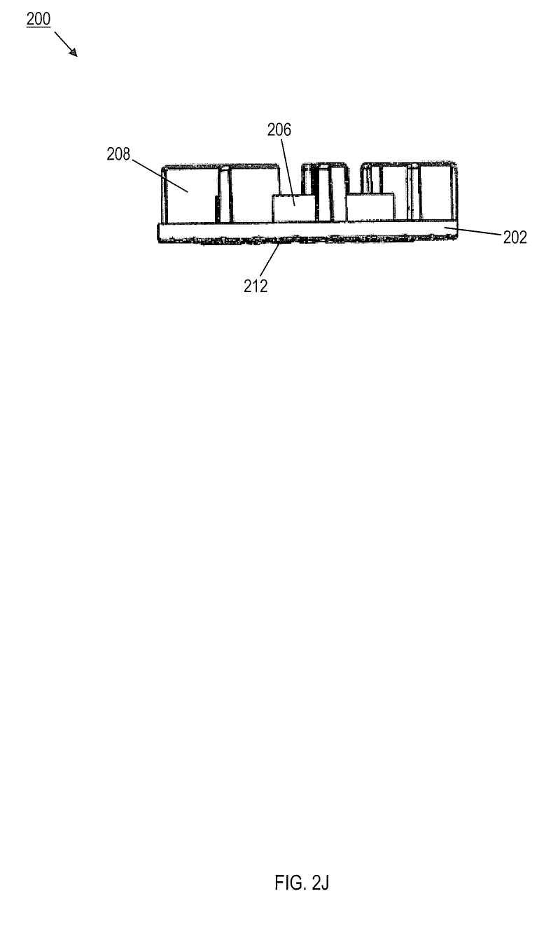

Referring to FIGS. 2A-2J, the turbine valve 200, according to an exemplary embodiment, is used to cover and uncover the nozzles 122 to produce the pulsating spray pattern. In one exemplary embodiment, the turbine valve 200 is made of plastic and is formed by injection molding. One of ordinary skill in the art will appreciate that the turbine valve could be made from other suitable materials and/or formed by other suitable processes. The turbine valve 200 is disposed in the annular chamber 132 so as to be surrounded by the outer wall 116, the inner wall 118, the front wall 134 and the rear wall 136. In one exemplary embodiment, a retaining member 146 can be used to secure the turbine valve 200 in the annular chamber 132, as well as set a limit on axial movement of the turbine valve 200 between the front wall 134 and the retaining member 146. In one exemplary embodiment, the retaining member 146 is a washer that is friction fit around the inner wall 118, such that the washer rests on the second ledge 144 of the inner wall 118 (see FIGS. 1B and 1C). One of ordinary skill in the art will appreciate that other types of retaining members could be used, as well as using the rear wall 136 itself as a retaining member.

The turbine valve 200 has an annular shape and includes a base plate 202 with a central opening 204. A raised wall 206 extends above the base plate 202, such that an inner surface of the raised wall 206 coincides with the central opening 204. One or more vanes 208 are formed on the base plate 202 and are spaced circumferentially around the raised wall 206. In one exemplary embodiment, the vanes 208 have a substantially arcuate shape. Each vane 208 includes a portion that contacts an upper surface of the raised wall 206 and an overhanging portion 210 that extends past the raised wall 206 and into the central opening 204. In one exemplary embodiment, the vanes 208 do not have the overhanging portions 210. In one exemplary embodiment, nine vanes 208 are formed on the base plate 202. The exemplary vanes 208 are evenly spaced from one another, i.e., every 40 degrees on the base plate 202 in the case of nine vanes 208.

A size of the central opening 204 of the base plate 202 is substantially the same as a size of the largest circumference of the inner wall 118 (i.e., the first portion of the inner wall 118), such that the turbine valve 200 fits over and surrounds the first portion of the inner wall 118. When the turbine valve 200 is in the idle state, the overhanging portions 210 of the vanes 208 rest on the first ledge 142 of the inner wall 118. When the turbine valve 200 enters the operational state (as described below), the overhanging portions 210 of the vanes 208 interface with the inner wall 118 (e.g., the third portion of the inner wall 118) to constrain radial movement of the turbine valve 200 within the annular chamber 132.

A lower surface 212 of the base plate 202 has structure (e.g., intentional angular geometry) to reduce the contact area between the base plate 202 and the front wall 134, thereby reducing the friction between the base plate 202 and the front wall 134 as the turbine valve 200 transitions from the idle state to the operational state, as well during any incidental contact that may occur during the operational state. Furthermore, the lower surface 212 of the base plate 202 has a predetermined slope from an outer edge of the base plate 202 to the central opening 204 of the base plate 202 (see FIG. 2F) to reduce the contact area between the base plate 202 and the front wall 134, which further reduces the friction between the base plate 202 and the front wall 134 as the turbine valve 200 transitions from the idle state to the operational state. In one exemplary embodiment, the predetermined slope is approximately 3 degrees. Further still, as noted above, the front wall 134 can include the raised pads 138 at the opening of each of the nozzles 122 and the ribs 140 extending between the raised pads 138 to reduce the contact area between the base plate 202 and the front wall 134, which further reduces the friction between the base plate 202 and the front wall 134 as the turbine valve 200 transitions from the idle state to the operational state.

The texture of the lower surface 212 includes a plurality of notches 214 formed therein (see FIGS. 2B, 2D and 21). The notches 214 include a side that forms an angle theta (θ) relative to the plane of the base plate 202 (see FIG. 2I). The angle θ can have any value that allows the turbine valve 200 to rise on a fluidic bearing when in the operational state, as described below. In one exemplary embodiment, the angle θ is less than 30 degrees. In one exemplary embodiment, the angle θ is between 1 and 10 degrees. In one exemplary embodiment, the angle θ is approximately 15.5 degrees.

The base plate 202 includes an open portion 216 and a closed portion 218. The aforementioned notches 214 border the open portion 216 of the base plate 202 and extend across the closed portion 218 of the base plate 202 (see FIGS. 2B, 2D and 2I). The open portion 216 of the base plate 202 allows the water from the water supply source passing through from the input side 128 of the partial head portion 100 to reach one or more of the nozzles 122 and continue out through the corresponding nozzle openings 106 on the output side 130 of the partial head portion 100. Conversely, the closed portion 218 of the base plate 202 covers one or more of the nozzles 122, thereby preventing the water from entering the nozzles 122 and flowing out the corresponding nozzle openings 106. The vanes 208 formed above the open portion 216 of the base plate 202 extend across the open portion 216 of the base plate 202. However, because the vanes 208 are relatively thin, the vanes 208 do not substantially impede the flow of the water through the open portion 216 of the base plate 202.

Operation of the turbine valve 200 in the annular chamber 132 of the partial head portion 100 of the multi-function showerhead, according to one exemplary embodiment, will now be described.

The open portion 216 of the base plate 202 is a contiguous portion spanning 240 degrees, while the closed portion 218 of the base plate 202 is a contiguous portion spanning 120 degrees. Accordingly, in the case of the three evenly spaced nozzles 122 (i.e., each adjacent pair of the nozzles 122 separated by 120 degrees), when one of the nozzles 122 is completely covered by the closed portion 218 of the base plate 202, the remaining two nozzles 122 are within the open portion 216 of the base plate 202. One of ordinary skill in the art will appreciate that the open portion 216 and/or the closed portion 218 could be formed from several discrete portions of the base plate 202 instead of a single, contiguous portion of the base plate 202.

When the user selects a water delivery function that produces the pulsating spray pattern, water entering the partial head portion 100 from a water supply source is allowed to enter the annular chamber 132. In particular, the water enters the annular chamber 132 through openings (not shown) in the rear wall 136 having a predetermined angle. In one exemplary embodiment, the openings have a shallow angle (e.g., an angle less than 45 degrees). The water entering the annular chamber 132 at the predetermined angle strikes one or more of the vanes 208 to cause the turbine valve 200 to rotate within the annular chamber 132. In particular, the turbine valve 200 begins to transition from the idle state to the operational state. In one exemplary embodiment, the turbine valve 200 achieves a stable rotation of between 1140 and 1310 rpm in the operational state. One of ordinary skill in the art will appreciate that the general inventive concept is applicable to any fluid spray apparatus having an operational state, regardless of the rpm range defining the operational state.

During the operational state, pressure from the water entering the annular chamber 132 causes the turbine valve 200 to move toward and contact the front wall 134. However, some of the water passing through the open portion 216 of the base plate 202 of the turbine valve 200 flows under the base plate 202 and forms a thin film of water between the front wall 134 (including the raised pads 138 and the ribs 140) and the base plate 202. The notches 214 of the turbine valve 200 function as fins that interact with the thin film of water, such that the angular velocity of the turbine valve 200 creates elevated pressure between the turbine valve 200 and the front wall 134 of the annular chamber 132. This elevated pressure overcomes the forces that tend to move the turbine valve 200 toward the front wall 134, such as the force from the water hitting the turbine valve 200 and the force from the pressure differential near the blocked nozzles 122. As a result, the thin film of water acts as a hydrodynamic bearing that causes axial displacement of the base plate 202 of the turbine valve 200 away from the front wall 134 of the annular chamber 132.

While most of the water flowing through the open portion 216 of the base plate 202 flows through the nozzles 122 that are not blocked by the closed portion 218 of the base plate 202, enough of the water remains between the base plate 202 and the front wall 134 to maintain the hydrodynamic bearing during the operational state of the turbine valve 200. Accordingly, once the turbine valve 200 achieves a stable rotational speed so as to enter the operational state, contact between the turbine valve 200 and the front wall 134 of the annular chamber 132 is reduced, if not eliminated. In one exemplary embodiment, a thickness of the hydrodynamic bearing is less than 0.005 inches.

As noted above, the axial movement of the turbine valve 200 (away from the front wall 134) is limited by the retaining member 146 (e.g., a washing, the rear wall 136). Thus, during the operational state, the turbine valve 200 is axially constrained between the hydrodynamic bearing and the retaining member 146. However, given the forces acting on the turbine valve 200 (i.e., that urge the turbine valve 200 against the front wall 134), the turbine valve 200 will likely not be displaced to an extent that it will contact the retaining member 146.

When the turbine valve 200 rotates in the annular chamber 132, the closed portion 218 of the base plate 202 repeatedly covers a different one of the three nozzles 122 in sequence. Thus, the water flows through the open portion 216 of the base plate 202, through the currently uncovered pair of adjacent nozzles 122 and out the corresponding nozzles openings 106, wherein the currently uncovered pair of adjacent nozzles 122 is sequentially changing as the turbine valve 200 rotates in the annular chamber 132. As a result, the multi-function showerhead produces the pulsating spray pattern.

However, because the hydrodynamic bearing separates the rotating turbine valve 200 from the front wall 134 of the annular chamber 132, the force needed to rotate the turbine valve 200 is reduced. Furthermore, once rotating, the turbine valve 200 is less likely to be stopped or substantially slowed by incidental contact between the turbine valve 200 and the front wall 134 of the annular chamber 132. Further still, the turbine valve 200 and the front wall 134 of the annular chamber are subjected to less wear. Furthermore, because the hydrodynamic bearing separates the rotating turbine valve 200 from the front wall 134 of the annular chamber 132, a fluid spray apparatus (e.g., the multi-function showerhead) using the turbine valve 200 generates less noise and, thus, operates more quietly.

The above description of specific embodiments has been given by way of example. From the disclosure given, those skilled in the art will not only understand the general inventive concept and its attendant advantages, but will also find apparent various changes and modifications to the structures and methods disclosed. For example, the notches on the turbine valve can have any shape and/or arrangement that is sufficient to create the fluidic bearing. As another example, one of ordinary skill in the art will appreciate that any plurality of nozzles could be used to produce the pulsating spray pattern. As yet another example, any number and/or arrangement of vanes could be used if sufficient to impart rotation to the turbine valve when struck by the fluid. It is sought, therefore, to cover all such changes and modifications as fall within the spirit and scope of the general inventive concept, as defined by the appended claims, and equivalents thereof.

1. An apparatus for discharging a fluid to produce a pulsating spray pattern, the apparatus comprising:
a chamber having a plurality of openings formed in a wall of the chamber, and
a turbine valve disposed in the chamber,
wherein the turbine valve is operable to rotate under the force of a fluid flowing into the chamber,
wherein at least one of the openings is covered during rotation of the turbine valve,
wherein at least one of the openings is uncovered during rotation of the turbine valve,
wherein a fluidic bearing is formed between the wall of the chamber and the turbine valve during rotation of the turbine valve, and
wherein the fluidic bearing displaces the turbine valve away from the wall.

2. The apparatus of claim 1, wherein the fluidic bearing reduces contact between the turbine valve and the wall.

3. The apparatus of claim 1, wherein the fluidic bearing eliminates contact between the turbine valve and the wall.

4. The apparatus of claim 1, wherein the fluidic bearing is maintained while the turbine valve rotates between 1140 and 1310 rpm.

5. The apparatus of claim 1, wherein the turbine valve includes at least one vane, and
wherein the fluid flowing into the chamber contacts the vane to cause the turbine valve to rotate in the chamber.

6. The apparatus of claim 5, wherein the vane has an arcuate shape.

7. The apparatus of claim 1, wherein a side of the turbine valve facing the wall includes a plurality of notches.

8. The apparatus of claim 7, wherein each of the notches forms an angle with the side of less than 30 degrees.

9. The apparatus of claim 8, wherein the angle is between 1 and 10 degrees.

10. The apparatus of claim 1, wherein a side of the turbine valve facing the wall has a slope from an outer edge of the side toward a center of the side.

11. The apparatus of claim 10, wherein the slope is less than 30 degrees.

12. The apparatus of claim 11, wherein the slope is approximately 3 degrees.

13. The apparatus of claim 1, wherein a thickness of the fluidic bearing is less than 0.005 inches.

14. The apparatus of claim 1, wherein an annular pad surrounds each of the openings and projects into the chamber.

15. The apparatus of claim 14, wherein at least one rib extends between each pair of adjacent pads and projects into the chamber.

16. A turbine valve for rotating in a chamber to produce a pulsating spray pattern of a fluid flowing through the chamber, the turbine valve comprising:
an annular base;
at least one vane extending from a first side of the annular base; and
a plurality of notches formed on a second side of the annular base,
wherein the vane is operable to cause the turbine valve to rotate in the chamber if the fluid contacts the vane; and
wherein the notches are operable to form a fluidic bearing as a result of the fluid flowing between the second side of the annular base and a first wall of the chamber.

17. The turbine valve of claim 16, wherein the fluidic bearing displaces the turbine valve away from the first wall.

18. The turbine valve of claim 16, wherein the annular base includes a central opening, and
wherein the central opening is operable to surround a second wall of the chamber, the second wall being perpendicular to the first wall.

19. The turbine valve of claim 16, wherein each of the notches forms an angle with the second side of less than 30 degrees.

20. The turbine valve of claim 19, wherein the angle is between 1 and 10 degrees.

21. The turbine valve of claim 16, wherein the second side of the turbine valve has a slope from an outer edge of the second side toward a center of the second side.

22. The turbine valve of claim 21, wherein the slope is less than 30 degrees.

23. The turbine valve of claim 22, wherein the slope is approximately 3 degrees.

24. The turbine valve of claim 16, wherein the vane has an arcuate shape.
